(19) United States
(12) Patent Application Publication
(10) Pub. No.: US 2016/0085762 A1
(43) Pub. Date: Mar. 24, 2016

(54) Multi-Scene Rich Media Content Rendering System

(71) Applicant: Smoothweb Technologies Ltd., Hong Kong (HK)

(72) Inventor: Rajiv Trehan, Tokyo (JP)

(21) Appl. No.: 14/494,451

(22) Filed: Sep. 23, 2014

(51) Int. Cl. G06F 17/30

(52) U.S. Cl. CPC G06F 17/30058

(57) ABSTRACT

The present invention provides a system and method for enabling a media-board presentation to facilitate smooth transition of media content from one scene to another without any glitches or interruptions. The system provides a multi-scene rich media content rendering algorithm, wherein the said system performs transition of asset(s) from one scene to another scene by identifying common asset(s) across the scenes and asset(s) common across the scenes are modified according to meta-data relating to the position, size, depth (or layer depth), alpha, volume, aspect and effect with respect to the another scenes, therefore facilitating smooth transition of media content.

### FIELD OF INVENTION

The present invention generally relates to rendering media content. More particularly, the present invention relates to a system and method of facilitating the smooth transition of the media content from one scene to another, where the play order of the scenes is not predetermined.

### BACKGROUND OF THE INVENTION

Adding media content such as audio, video, text, image, pdf, MS office Documents etc. to another media is done on presentation module or viewer. The presentation module or viewer combines one or more media content in real time or otherwise, via software, in a specified format. The presentation module or viewer further regulates relaying of scene(s) from one specific source to another and monitors these scene(s). The process is quite simple when the continuity of the media has to be broken as there is no requirement for alignment of the scenes and the place of insertion is predetermined. A simple example of combining media on presentation module or viewer by breaking the continuity is inserting a commercial during a movie. The presentation module or viewer stops the movie after a predetermined running and a commercial follows instantly or shortly with no requirement of alignment. However, the whole equation changes when insertion is to be made during a live transmission or when media is still playing in the background, because such type of insertion requires precise alignment of the scenes with fast seamless switching without any undesirable glitches such as pixelation, flickering, delay in streaming video, undesirable interruptions, dropping content etc.

However, utilizing software to remove the glitches while performing media content transition from one scene to the next is being addressed by one off application development, which results in operating system dependency. Moreover, currently, there is no method and system to bring together different types of media content such as video, audio, image, pdf, office documents on a scene and integrate it into a digital presentation that can be played on different types of hardware devices using different types of technology. The integration of such asset(s) from one scene to another often results in undesirable glitches for example delays in streaming video, undesirable interruptions, dropping content and pixelation or flickering etc. Further, software development to support additional operating systems introduces a development risk such as bugs in the code, additional time for development, testing the application and inflexibility of application.

The undesirable glitches can also be removed by using hardware that could manipulate key frames, for example TV industry utilizes hardware capable of fast seamless switching by making a layered architecture in which stream management is independent of display management. However, the technology is limited by the requirement of alignment of the common frames perfectly; otherwise undesirable glitches such as pixelation appear.

At present there is no rendering tool that facilitates the smooth transitioning of media content from one scene to another by modifying properties of media content asset(s) without any undesirable glitches that occur while combining different types of media content without any predetermined sequence.

Therefore, to overcome the above problems the present invention provides a new system and method for rendering multi-scene rich media content on a media-board presentation for facilitating smooth transition of media content.

### SUMMARY OF THE INVENTION

A system for facilitating smooth transition of media content from one scene to another scene, the system comprising: media-board application to create a media-board presentation; multi-scene rich media content rendering algorithm, for modifying and managing attributes or properties with respect to media content asset(s); and media-board player, an implementation of the multi -scene rich media content rendering algorithm to play media-board presentations; wherein, said media-board presentation comprises one or more scenes; each scene possesses multiple different asset(s), which are tagged with a unique identifier; and said multi-scene rich media content rendering algorithm pre-checks; and transitions these tagged asset(s) from one scene to another by identifying tagged asset(s) common across two scenes, therefore tagged asset(s) common across scenes are modified according to meta-data relating to the position, size, depth (or layer depth), alpha, volume, aspect and effect with respect to other scene, therefore facilitating the smooth transition of media content.

The media-board application creates a media-board presentation consisting of scenes; each scene may possess multiple asset(s), each asset is tagged with a unique identifier and has meta-data relating to its position, size, alpha, volume, aspect and effect; an asset may appear on multiple scenes, the unique identifier will remain the same on each scene, however, its meta-data may be different; wherein, said multi-scene rich media content rendering algorithm expects a media-board presentation as input and defines how assets are managed in memory as we transition these tagged asset(s) from one scene to another scene. The multi scene rich media content rendering algorithm specifies that assets that are common from the current scene to the new scene, identified by the unique identifier, are modified according to meta-data such as position, size, depth (or layer depth), alpha, volume, aspect and effect thereby facilitating smooth transition of the asset. Assets that do not appear on the new scene and have no potential for resuming playing later may be removed from memory and those that could have potential to be resumed are simply suspended/paused.

Media content includes but is not limited to the video, audio, graphic, text, pdf, MS office document etc or combination thereof as components prepared on the media-board presentation. For example, any media content such as an audio, video, text, document etc having display properties can be modified or managed from one scene to another to play smoothly without any glitches or interruptions on a media-board presentation.

The present invention provides a method for facilitating smooth transition of media content from one scene to another scene by a multi-scene rich media content rendering algorithm, the method comprising: creating a media-board presentation, modifying and managing attributes or properties with respect to asset(s) of one or more scenes; where each scene possesses multiple different asset(s); pre-checking and tagging each asset with a unique identifier; and further transition of these tagged asset(s) from one scene to another scene and tagged asset(s) common across both scenes are modified and managed according to meta-data relating to the position, size, depth (or layer depth) information, alpha, volume, aspect and effect with respect to other scene, therefore facilitating smooth transition of media content asset(s); wherein, the media content on the media-board presentation is played without any glitches or interruptions.

### BRIEF DESCRIPTION OF THE DRAWINGS

The following invention will be described with reference to the following drawings of which:

FIG. 1 illustrates a flowchart describing a process of a multi-scene rich media content rendering algorithm, in which various embodiment of the present invention may be practiced;

FIG. 2 illustrates an exemplary process of a multi-scene rich media content rendering system, in which various embodiment of the present invention may be practiced;

FIG. 3 illustrates an exemplary method for rendering multi-scene rich media content, in which various embodiment of the present invention may be practiced;

FIG. 4 illustrates detailed block diagram of multi-scene rich media content rendering system;

FIG. 5A-5E illustrates the user interface of media-board presentation for modifying and managing asset(s) on one or more scenes;

FIG. 6A-6C are screen shots of a media-board presentation being played by a media-board player;

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated or distorted and not drawn on scale for illustrative purposes. Where an indefinite or definite article is used when referring to a singular noun e.g. “a” or “an”, “the”, this includes a plural of that noun unless something else is specifically stated.

The present invention now will be described more fully hereinafter with reference to the accompanying drawings, in which some, but not all embodiments of the inventions are shown. While the following description details the preferred embodiments of the present invention is not limited in its application to the details of construction and arrangement of the parts illustrated in the accompanying drawings.

With reference to the figures, numerical designation has been given for each element to facilitate the reader's understanding of the present invention, and particularly with reference to the embodiments of the present invention illustrated in the figures; various preferred embodiments of the present invention are set forth below. The enclosed description and drawings are merely illustrative of preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

### Definition(s):

The term “media-board application” is an authoring tool and it is used to create a media-board presentation.

The term “media-board presentation” is the output of the media-board application or authoring tool and is in XML format. The XML may be stored as a file or passed directly to a program as a parameter or stream.

The term “media-board player” is an implementation of the multi-scene rich media content rendering algorithm for playing/rendering media-board presentations on display devices such as desktop, laptop, tablet, smart phone etc.

The term “media content” includes but is not limited to the video, audio, graphic, text, pdf, MS office document etc or combination thereof. Media content can also reference a media -board presentation. Therefore, a scene media content asset can also reference a media-board presentation so that one or more media-board presentations may be embedded/nested in another media-board presentation. Each media board presentation is rendered in its own stream.

Any media content such as video, audio, graphic, text, pdf, MS office document etc or combination thereof can be managed or rendered from one scene to another to avoid any glitches or interruptions while playing on a media-board player. For example, any media content such as a movie is stored, modified and played with other kinds of media such as text in form of subtitles. Similar technology can also be utilized in case of live streaming video wherein text in form of statistics and/or other information; such as in a boxing match fight history, physical statics, upcoming fight, twitter and other information may be displayed. Further extra features such as commentary, additional footage, trailers and the like may also be added. Although the preferred media content is video it does not in any way restricts the scope of application of the present invention.

A system for facilitating smooth transition of media content from one scene to another scene, the system comprising: media-board application to create a media-board presentation; multi-scene rich media content rendering algorithm, for modifying and managing attributes or properties with respect to media content asset(s); and media-board player, an implementation of the multi -scene rich media content rendering algorithm to play media-board presentations; wherein, said media-board presentation comprises one or more scenes; each scene possesses multiple different asset(s), which are tagged with a unique identifier; and said multi-scene rich media content rendering algorithm pre-checks and transitions these tagged asset(s) from one scene to another by identifying tagged asset(s) across two scenes, therefore tagged asset(s) common across scenes are modified according to meta-data relating to the position, size, depth (or layer depth), alpha, volume, aspect and effect with respect to the another scene, therefore facilitating smooth transition of media content.

An asset may appear on multiple scenes, the unique identifier will remain the same on each scene, however, its meta-data may be different; wherein, said multi-scene rich media content rendering algorithm takes a media-board presentation as input and defines how assets are managed in memory as we transition these tagged asset(s) from one scene to another scene. Assets that do not appear on the new scene and have no potential for resuming playing later may be removed from memory and those that could have potential to be resumed are simply suspended/paused.

A multi-scene rich media content rendering algorithm is for facilitating the smooth transitioning of the media content asset(s), allowing attributes or properties with respect to media content asset(s) to be modified or managed; and playing the media content without any technical glitches such as delays, undesirable interruptions or dropped content without any pixelation or flickering etc.

The Media-board application is used to create media-board presentations. A media-board presentation is played/displayed/rendered using an implementation of the multi-scene rich media content rendering algorithm. A media-board presentation may contain one or more scenes, each scene comprising of zero or more media content asset(s). Scenes may transition from one scene to another scene based on the time-elapsed, user interaction (mouse/touch) or external stimuli (e.g. specific date or time, warning signal of some sort). Each asset in a scene is assigned with a unique identifier such as name, id. The feature of the multi-scene rich media content rendering algorithm is the ability to transition an asset(s) smoothly from one scene to another without undesirable glitches for example, delays, interruptions or dropped content with pixelation or flickering etc. The multi-scene rich media content rendering algorithm utilizes the unique identifier of each asset(s) and the meta-data of each asset(s) to achieve the smooth transition effect. The media-board presentation stores meta-data for each scene and each asset on a scene. In the media-board presentation, asset(s) may occur on one or more scenes; however the unique identifier remains the same while the meta-data may differ (Some meta-data example for each of the aforementioned are presented below in the Table 1), wherein the asset(s) among the scenes can be unloaded or reset or rewound while the media-board presentation is being played.

TABLE 1

| Object | Meta-Data Examples |
|---|---|
| Media-board | site=“smoothos.com” mask_width=“640” mask_height=“480” |
| presentation | |
| Scene | name=“Scene Two” duration=“5” auto_play=“true” build_effect=“flyinleft” |
| Asset | path=“33216/1380433696708441000_mp4.mp4”fhode=“2726526”title=“sintel |
| | Trailer” |

The system can be configured for different types of hardware devices including but not limited to desktops or laptops, tablets, mobile phones etc. Further, the system may be configured for different types of software(s) including but not limited to Windows, Mac, and Linux etc. Wherein, the said system utilizes different types of technology such as htm15, Flash, Silverlight, C/C++ etc. The system also provides animations and effects for the media content.

The multi-scene rich media content rendering algorithm defines how to perform rendering by pre-checking asset(s) of scene(s) on a media-board presentation to find the same or common asset(s) that may be present on the next scene, where the next scene is not predetermined. The common assets are identifiable by their unique identifier. The algorithm shall not redraw asset(s) for scenes that existed in the previous scene and is/are present in the new scene. The algorithm allows common assets between current and new scene are not to be redrawn, their attributes (meta-data relating to the position, size, depth (or layer depth), alpha, volume, aspect and effect) are modified according to their properties on the new scene. Also, the multi-scene rich media content rendering algorithm can be used for smooth rendering of media contents, where the next scene is predetermined.

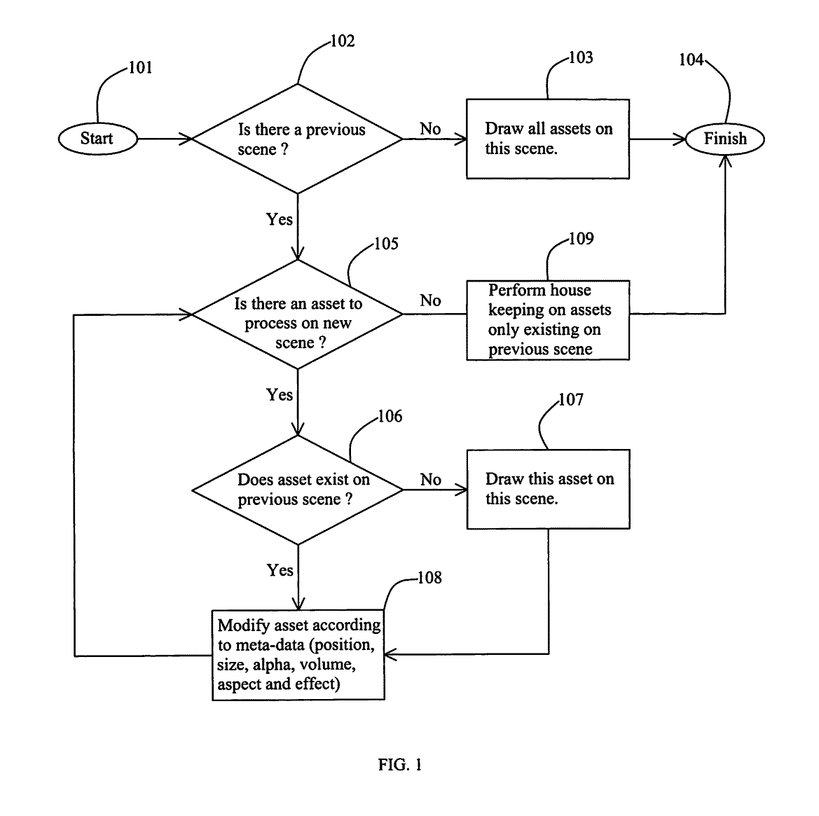

FIG. 1 is a flowchart describing the process of a multi-scene rich media content rendering algorithm, which illustrates the process of facilitating smooth transition of media content from previous scene to new scene. The rendering starts 101 by assessing a media-board presentation and checking for a previous scene 102 on the media-board presentation. If there is no previous scene then the algorithm draws all the asset(s) on the new scene 103 and finishes 104 rendering without transitioning any asset(s). Further, in case, there is a previous scene 102 then the algorithm checks for asset(s) to be processed 105. The algorithm processes the zero or more assets on the new scene 105 until there are no more assets to process. In case there is/are asset(s) for processing then the algorithm further checks for common asset(s) 106 between new scene and previous scene. In case, there is/are no common asset(s) then the algorithm draws all the asset(s) 107 on current scene. If there is/are common asset(s) between the new scene and previous scene then asset(s) are modified according to meta-data relating to the position, size, depth (or layer depth), alpha, volume, aspect and effect 108 with respect to the new scene, therefore facilitating smooth transition of media content. The algorithm finishes by processing all assets only on the previous scene and performs required housekeeping 109, and then the algorithm finishes 104.

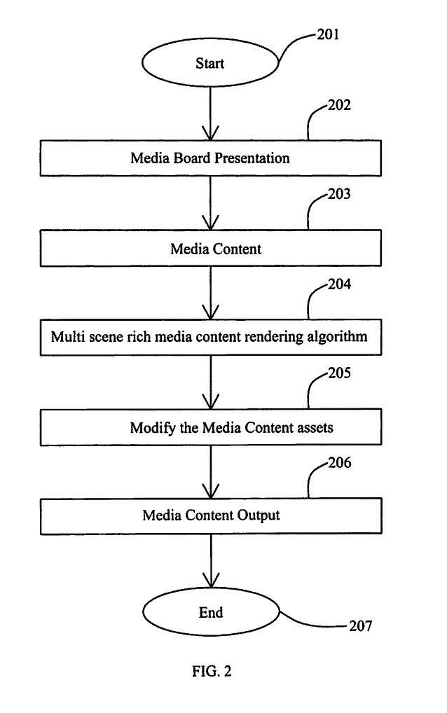

FIG. 2 is an exemplary process of a multi-scene rich media content rendering algorithm for facilitating smooth transition of media content. The algorithm starts 201 with a media-board presentation 202, which contains media content 203 to be rendered. The multi-scene rich media rendering algorithm 204 modifies and manages attributes of media content asset(s) 205. The rendered synchronized media content including transition of assets is presented on output display device 206 and finishes 207.

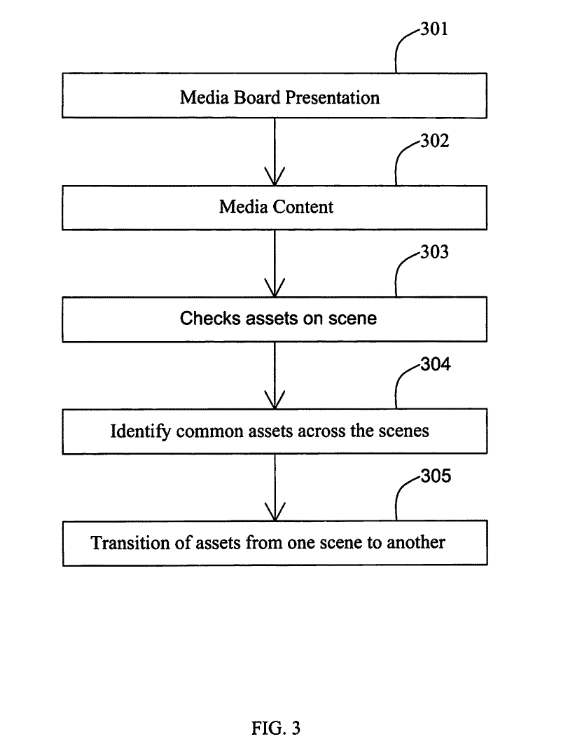

Similarly in FIG. 3 which provides an exemplary method for rendering media content by using multi-scene rich media content rendering algorithm, said method in which a media-board presentation 301 with media content 302 to be modified and managed. The algorithm checks asset(s) of the scenes 303. Further identifies common asset(s) shared across two scenes 304 to facilitate transition 305 of these asset(s) from one scene to another scene. The asset(s) common across two scenes are modified according to meta-data relating to the position, size, depth (or layer depth) alpha, volume, aspect and effect with respect to the another scene, therefore facilitating smooth transition of media content; wherein, the media content on the media-board presentation is played without any glitches or interruptions.

The present invention provides a method for facilitating smooth transition of media content from one scene to another scene by a multi-scene rich media content rendering algorithm, the method comprising: creating a media-board presentation, modifying and managing attributes or properties with respect to asset(s) of one or more scenes; where each scene possesses multiple different asset(s); pre-checking and tagging each asset(s) with unique identifier; and further transition of these tagged asset(s) from one scene to another scene and tagged asset(s) common across both scenes are modified and managed according to meta-data relating to the position, size, depth (or layer depth), alpha, volume, aspect and effect with respect to other scene, therefore facilitating smooth transition of media content asset(s); wherein, the media content on the media-board presentation is played without any glitches or interruptions because the transition of media content asset(s) does not interrupt the media streaming and rendering process.

The multi-scene rich media content rendering algorithm takes a media-board presentation as input; manage assets that do not appear on the new scene (if there is no potential for continual playing later may be removed from memory or those that could have potential to be continued are suspended); manage assets that only appear on the new scene and transition of assets that are common to both the current and new scenes.

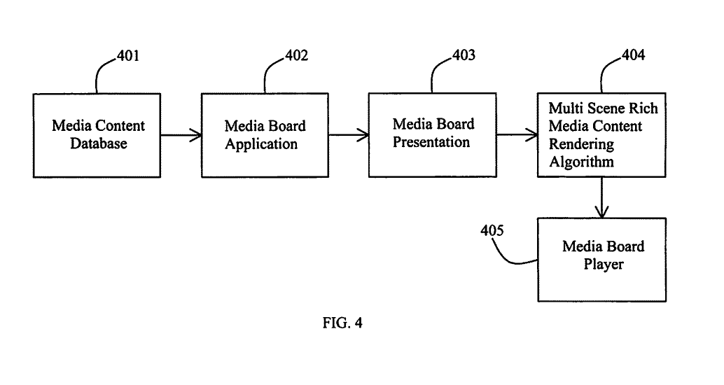

FIG. 4 is a detailed block diagram of the present system, as shown the system comprises of a media content database 401, a media-board application 402, a media-board presentation 403, multi-scene rich media content rendering algorithm 404 and media-board player 405. The media-board application uses media contents from the media content database or other sources, and saves them to the media-board presentation. In this instance, the media-board presentation 403 includes scene information and annotation information of the media contents. The multi-scene rich media content rendering algorithm 404 renders the media content of the media-board presentation 403 and the media-board player 405 plays/renders the presentation.

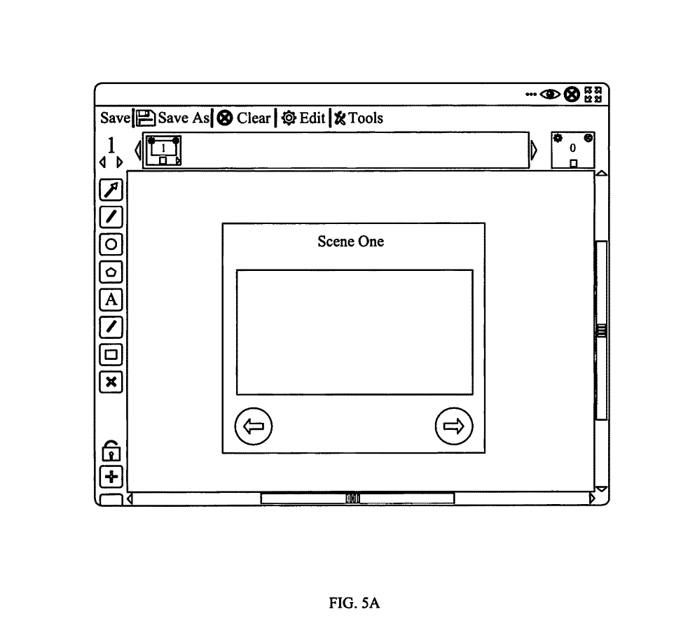

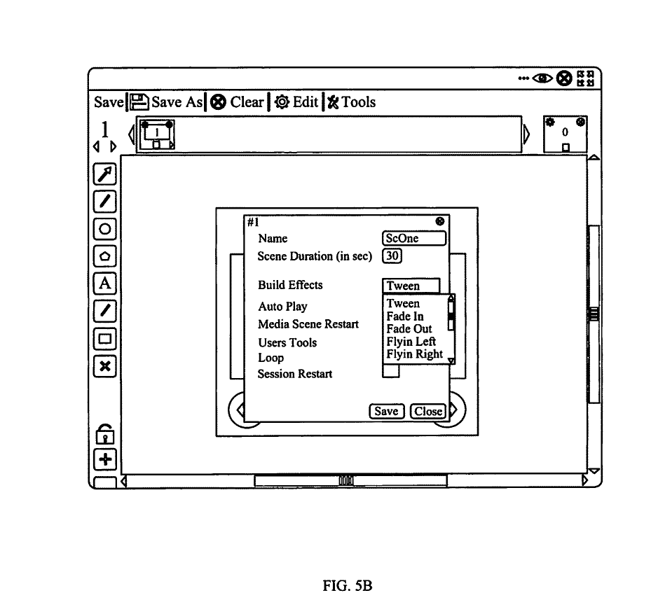

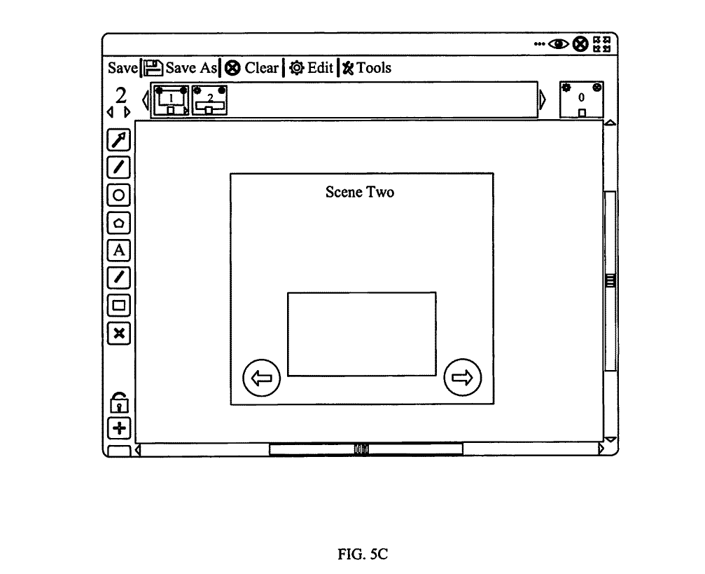

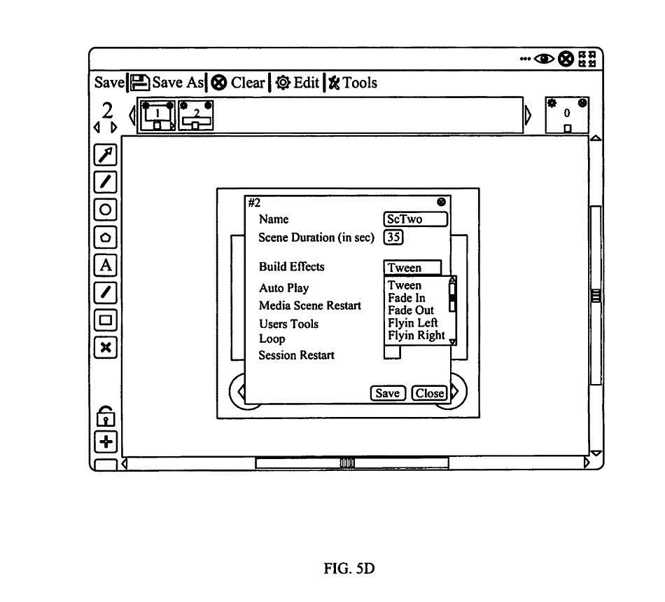

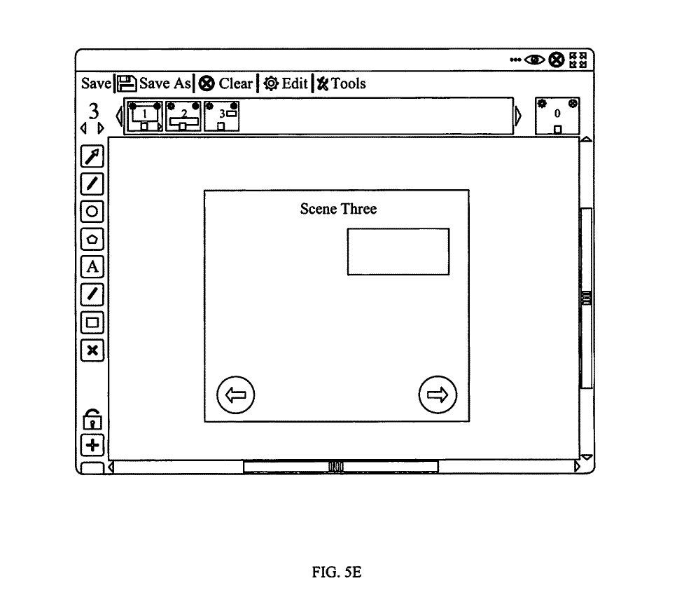

FIG. 5A illustrates how attributes of a scene on media-board presentation can be added or modified; wherein a scene namely scene one may contain a video.

FIG. 5B illustrates another example of adding or modifying attributes for scene one. The attributes defined although not limited by the current disclosure includes features like naming scene, providing the scene duration, providing effects such as tween, fade in, fade out, flyin left, flyin right etc., providing an auto play option, providing media scene restart option user tool, loop option and session restart option. Further, the added or modified scene with novel attributes can be saved as part of the media-board presentation.

FIG. 5C illustrates how attributes of a scene on media-board presentation can be added or modified; wherein a scene two contains a video.

FIG. 5D shows an example of adding or modifying attributes of scene two; wherein the attributes are defined, but not limited in scope by the current disclosure. The attributes include naming the scene, providing the scene duration, providing effects such as tween, fade in, fade out, flyin left, flyin right etc., providing an auto play option, providing media scene restart option user tool option, loop option and session restart option. Further scene two can be saved, linked to scene one and played.

FIG. 5E illustrates how attributes of a scene on media-board presentation can be added or modified; wherein a scene three contains a video.

FIG. 5F illustrates the attributes to be added on scene three on the media-board presentation. The scene three is also created using the same video but at a different position on media-board presentation and its alpha property (opaqueness) being modified from scene one and scene two. Further, scene can be saved, linked to scene one and scene two and played.

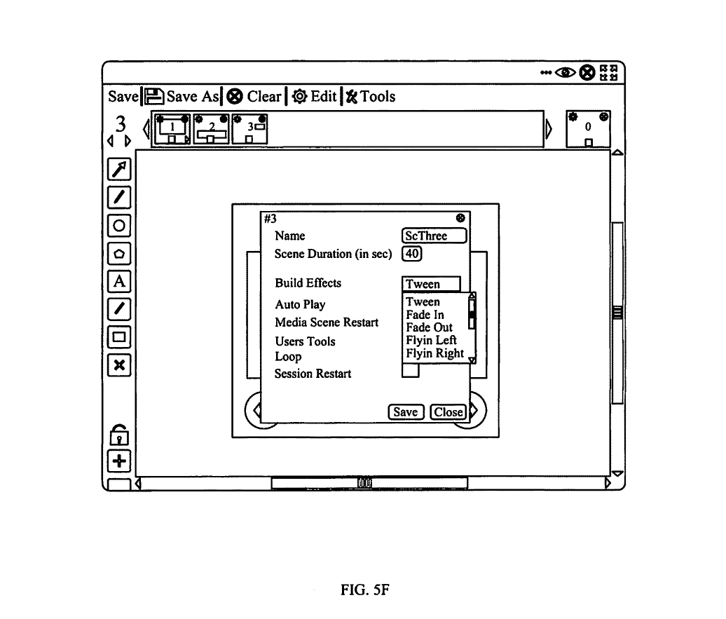

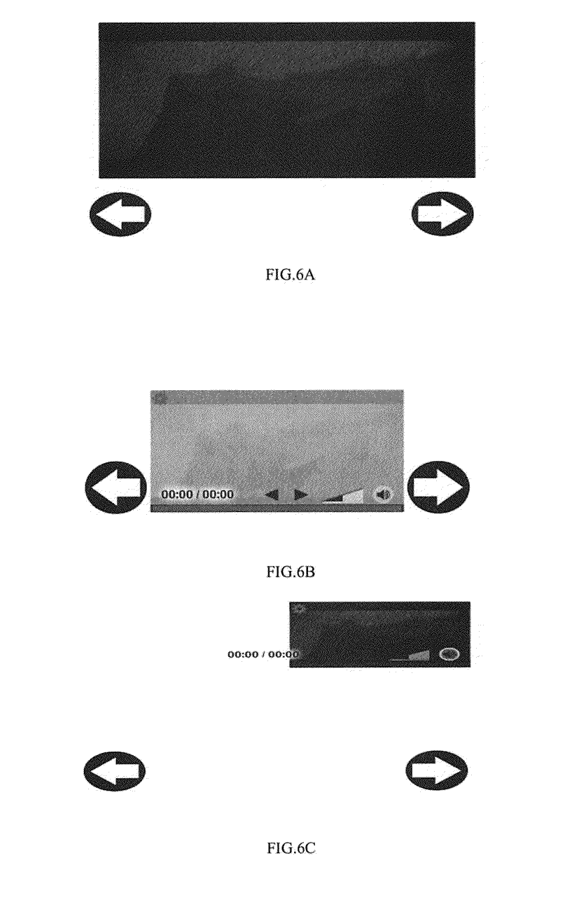

FIG. 6A-6C are screen shots of media-board presentation being played by a media-board player. In FIG. 6A, scene one has a media content asset (video) with desired attributes positioned at the left top corner of the media-board player. Similarly, in FIG. 6B, scene two the same media content asset (video) is positioned at the bottom of the media-board player with different opacity. FIG. 6C, scene three of the same media content asset (video) is positioned at the right top corner of the media-board player with different opacity.

In another embodiment of the present invention provide a method for media content rendering, the method comprising: creating a media-board presentation using a media-board application; said media-board presentation comprises of one or more scenes; where each scene possesses multiple different asset(s); each asset on a scene has meta-data, said metadata defines how asset(s) are displayed on the scenes; each asset has a unique identifier; transitioning of these asset(s) from one scene to another scene; allowing the media content asset to be played on the media-board presentation without any glitches or interruptions; and wherein play order of scenes are not predetermined.

One skilled in the art will appreciate that the embodiments provided above are exemplary and in no way limit the present invention.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The Abstract of the disclosure will allow the reader to quickly ascertain the nature of the technical disclosure. It is submitted with the understanding that it will not be used to interpret or limit the scope or meaning of the following claims.

What is claimed is:

1. A system for facilitating smooth transition of media content from one scene to another scene, the system comprising: media-board application to create a media-board presentation;
multi-scene rich media content rendering algorithm, for modifying and managing attributes or properties with respect to media content asset(s); and
media-board player, an implementation of the multi-scene rich media content rendering algorithm to play media-board presentations;
wherein, said media-board presentation comprises one or more scenes; each scene possesses multiple different asset(s), which are tagged with a unique identifier; and said multi- scene rich media content rendering algorithm pre-checks and transitions these tagged asset(s) from one scene to another by identifying tagged asset(s) across the two scenes, therefore tagged asset(s) common across scenes are modified according to meta-data relating to the position, size, depth (or layer depth), alpha, volume, aspect and effect with respect to the another scene, therefore facilitating smooth transition of media content.

2. The system of claim 1, wherein said media content includes video, audio, graphic, text, pdf, MS office document etc or combination thereof.

3. The system of claim 1, wherein the system can be configured for different types of hardware devices including but not limited to desktop(s), laptop(s), tablet(s), mobile phone(s) etc.

4. The system of claim 1, wherein the system can be configured for different types of software including but not limited to Windows, Mac, Linux etc.

5. The system of claim 1, wherein said system renders media content on different types of hardware devices utilising different types of technology such as htm15, Flash, Silverlight, C/C++ etc.

6. The system of claim 1, wherein said system perform transitions of tagged asset(s) from one scene to another scene, in which play order of scenes are not predetermined.

7. The system of claim 1, wherein said system perform transitions of tagged asset(s) from one scene to another scene, in which play order of scenes are predetermined.

8. The system of claim 1, wherein the asset(s) among the scenes can be unloaded/reset/rewound while playing a media-board presentation.

9. A method for facilitating smooth transition of media content from one scene to another scene by a multi-scene rich media content rendering algorithm, the method comprising:
creating a media-board presentation;
modifying and managing attributes or properties with respect to asset(s) of one or more scenes, where each scene possesses multiple different asset(s);
pre-checking and tagging each asset(s) with unique identifier and transition of these tagged asset(s) from one scene to another scene and tagged asset(s) common across both scenes are modified and managed according to meta-data relating to the position, size, depth (or layer depth), alpha, volume, aspect and effect with respect to the another scene, therefore facilitating smooth transition of media content asset(s);
wherein, the media content on the media-board presentation is played without any glitches or interruptions.

10. The method of claim 9, wherein said media content includes video, audio, graphic, text, pdf, MS office document etc or combination thereof.

11. The method of claim 9, wherein the system can be configured for different types of hardware devices including but not limited to desktop(s), laptop(s), tablet(s), mobile phone(s) etc.

12. The method of claim 9, wherein the system can be configured for different types of software including but not limited to Windows, Mac, Linux etc.

13. The method of claim 9, wherein said scene transition from one scene to next scene is based on time-elapsed, user interaction or external stimuli e.g. specific date or time, warning signal.

14. The method of claim 9, wherein the media-board presentation is played without any glitches or interruptions because the transition of media content asset(s) does not interrupt the media streaming and rendering process.

15. The method of claim 9, wherein said system performs transition of tagged asset(s) from one scene to another scene, in which play order of scenes are not predetermined.

16. In another embodiment of the present invention provide a method for media content rendering, the method comprising:
creating a media-board presentation using a media-board application; said media-board presentation comprises of one or more scenes; where each scene possesses multiple different asset(s);
identifying metadata embedded within the asset(s);
tagging each asset with unique identifier;
modifying and managing attributes or properties with respect to asset(s) of one or more scenes;
transitioning of these asset(s) from one scene to another scene;
allowing the media content asset on a scene in the media-board presentation be played without any glitches or interruptions; and
wherein, the play order of scenes are not predetermined.

17. The method of claim 16, wherein the media content media content includes video, audio, graphic, text, pdf, MS office document etc or combination thereof.

18. The method of claim 16, further comprising updating and inserting new media content into the media-board presentation.

19. The method of claim 16, the method further provides rendered media content on digital display devices.

20. The method of claim 16, wherein said scene transition from one scene to next scene is based on time-elapsed, user interaction or external stimuli e.g. specific date or time, warning signal.
